(19) United States
(12) Patent Application Publication
(10) Pub. No.: US 2023/0391217 A1
(43) Pub. Date: Dec. 7, 2023

(54) SELF-LOCATING CHARGING SYSTEMS FOR CHARGING ELECTRIFIED VEHICLES

(71) Applicant: FORD GLOBAL TECHNOLOGIES, LLC, Dearborn, MI (US)

(72) Inventors: Michael John Harmon, Northville, MI (US); Hussain Z. Tajmahal, Detroit, MI (US); Daveanand M. Singh, Arlington, VA (US); Stuart C. Salter, White Lake, MI (US); Hussein Berry, Dearborn, MI (US); David Brian Glickman, Southfield, MI (US); Annette Lynn Huebner, Highland, MI (US)

(21) Appl. No.: 17/830,500

(22) Filed: Jun. 2, 2022

(51) Int. Cl. B60L 53/38; B60L 53/51; B60L 53/53; B60L 53/12; G05D 1/02; H02J 7/00; H02J 50/10

(52) U.S. Cl. CPC B60L 53/38; B60L 53/51; B60L 53/53; B60L 53/12; G05D 1/0214; H02J 7/0042; H02J 50/10; H02J 2300/22

(57) ABSTRACT

Self-locating charging systems are disclosed for charging electrified vehicles equipped with traction battery packs. An exemplary self-locating charging system may include a beacon dock and a mobile rover configured to move between a stowed state within a docking space of the beacon dock and a charging alignment state in the mobile rover is aligned to a vehicle receiver module of an electrified vehicle for wirelessly transferring power. The self-locating charging system may further include a control module programmed to control movement of the mobile rover along a desired travel path between the stowed state and the charging alignment state.

### TECHNICAL FIELD

This disclosure relates generally to electrified vehicle charging, and more particularly to self-locating charging systems for providing autonomous and hands-free charging of electrified vehicles.

### BACKGROUND

Electrified vehicles can be selectively driven by one or more traction battery pack powered electric machines. The electric machines can propel the electrified vehicles instead of, or in combination with, an internal combustion engine. Some electrified vehicles, such as plug-in hybrid electric vehicles (PHEVs) and battery electric vehicles (BEVs), include charging interfaces for wirelessly charging the traction battery pack. The vehicle must be positioned in close proximity relative to charging equipment for achieving maximum wireless power transfer and efficiency. Typically, the owner/operation of the vehicle is responsible for aligning the vehicle relative to the charging equipment to enable the wireless power transfer.

### SUMMARY

A self-locating charging system according to an exemplary aspect of the present disclosure includes, among other things, a beacon dock and a mobile rover configured to move between a stowed state within a docking space of the beacon dock and a charging alignment state in which the mobile rover is aligned to a vehicle receiver module for wirelessly transferring power. The mobile rover includes a drive system comprising an axle assembly that includes a swing axle, a pair of wheels, an electric motor, and a pivot pin.

In a further non-limiting embodiment of the foregoing self-locating charging system, the beacon dock includes a solar panel and a battery bank.

In a further non-limiting embodiment of either of the foregoing self-locating charging systems, the docking space extends along a horizontal axis of the beacon dock for horizontally stowing the mobile rover.

In a further non-limiting embodiment of any of the forgoing self-locating charging systems, the docking space extends along a vertical axis of the beacon dock for vertically stowing the mobile rover.

In a further non-limiting embodiment of any of the forgoing self-locating charging systems, the beacon dock includes a ramped base for vertically stowing the mobile rover.

In a further non-limiting embodiment of any of the forgoing self-locating charging systems, the mobile rover is connected to the beacon dock by a tether.

In a further non-limiting embodiment of any of the forgoing self-locating charging systems, the beacon dock includes an automatic cable reel that is configured to either release the tether or collect the tether in coordination with a direction of movement of the mobile rover.

In a further non-limiting embodiment of any of the forgoing self-locating charging systems, the axle assembly is a front axle assembly, and the drive system further includes a rear axle assembly including a second swing axle, a second pair of wheels, a second electric motor, and a second pivot pin.

In a further non-limiting embodiment of any of the forgoing self-locating charging systems, the rear axle assembly and the front axle assembly are powered independently from one another.

In a further non-limiting embodiment of any of the forgoing self-locating charging systems, a mid-axle assembly is positioned between the rear axle assembly and the front axle assembly.

In a further non-limiting embodiment of any of the forgoing self-locating charging systems, the mobile rover includes a sensor system configured to monitor a 360 degree field-of-view about the mobile rover.

In a further non-limiting embodiment of any of the forgoing self-locating charging systems, the mobile rover includes a first communication system configured to communicate with a second communication system of an electrified vehicle that includes the vehicle receiver module.

In a further non-limiting embodiment of any of the forgoing self-locating charging systems, the mobile rover includes a casing and a transmitting module housed within the casing.

In a further non-limiting embodiment of any of the forgoing self-locating charging systems, the swing axle is configured to pivot about the pivot pin to either raise or lower a casing of the mobile rover relative to a surface.

In a further non-limiting embodiment of any of the forgoing self-locating charging systems, a control module is programmed to control the drive system for operating the mobile rover along a desired travel path between the stowed state and the charging alignment state.

A self-locating charging system according to another exemplary aspect of the present disclosure includes, among other things, a beacon dock, a mobile rover configured to move between a stowed state within a docking space of the beacon dock and a charging alignment state in which the mobile rover is aligned to a vehicle receiver module of an electrified vehicle for wirelessly transferring power. A control module is programmed to control movement of the mobile rover along a desired travel path between the stowed state and the charging alignment state. The control module is further programmed to distinguish between a permanent obstacle and a variable obstacle when mapping the desired travel path.

In a further non-limiting embodiment of the foregoing self-locating charging system, a first communication system is configured to communicate with a second communication system of the electrified vehicle for moving the mobile rover along the desired travel path.

In a further non-limiting embodiment of either of the foregoing self-locating charging systems, the control module is further programmed to control the mobile rover along the desired travel path based on feedback from a sensor system that is adapted to monitor a 360 degree field-of-view about the mobile rover.

In a further non-limiting embodiment of any of the foregoing self-locating charging systems, the control module is further programmed to command the mobile rover to return to the stowed state when a wireless charging event either ends or is interrupted.

In a further non-limiting embodiment of any of the foregoing self-locating charging systems, the mobile rover travels along a reverse path of the desired travel path when ordered to return to the stowed state.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a self-locating charging system for wirelessly charging an electrified vehicle. A mobile rover of the self-locating charging system is in a stowed state in FIG. 1.

FIG. 2 illustrates the self-locating charging system of FIG. 1 with the mobile rover in a navigating state.

FIG. 3 illustrates the self-locating charging system of FIG. 1 with the mobile rover in a charging alignment state for wirelessly charging the electrified vehicle.

FIG. 4 illustrates a self-locating charging system capable of charging multiple electrified vehicles.

FIG. 5 illustrates a beacon dock of a self-locating charging system.

FIG. 6 illustrates additional components of the beacon dock of FIG. 5.

FIG. 7 illustrates another exemplary beacon dock of a self-locating charging system.

FIG. 8 illustrates an automatic cable reel of the beacon dock of FIG. 5.

FIG. 9 illustrates additional functionality of the automatic cable reel of FIG. 8.

FIG. 10 is a top perspective view of a mobile rover of a self-locating charging system.

FIG. 11 is a bottom perspective view of the mobile rover of FIG. 10.

FIG. 12 is an exploded view of the mobile rover of FIG. 10.

FIG. 13 is a first side view of the mobile rover of FIG. 10.

FIG. 14 is a second side view of the mobile rover of FIG. 10.

FIG. 15 illustrates a raised position of the mobile rover of FIG. 10.

FIG. 16 schematically illustrates an auto-leveling feature of the mobile rover of FIG. 10.

FIG. 17 schematically illustrates a field of view that can be monitored by a sensor system of the mobile rover of FIG. 10.

FIG. 18 is a block diagram of a self-locating charging system.

FIG. 19 schematically illustrates functionality associated with a self-locating charging system.

FIG. 20 schematically illustrates a method for controlling a self-locating charging system to coordinate and execute wireless charging events.

### DETAILED DESCRIPTION

This disclosure relates to self-locating charging systems for charging electrified vehicles equipped with traction battery packs. An exemplary self-locating charging system may include a beacon dock and a mobile rover configured to move between a stowed state within a docking space of the beacon dock and a charging alignment state in the mobile rover is aligned to a vehicle receiver module of an electrified vehicle for wirelessly transferring power. The self-locating charging system may further include a control module programmed to control movement of the mobile rover along a desired travel path between the stowed state and the charging alignment state. These and other features of this disclosure are discussed in greater detail in the following paragraphs of this detailed description.

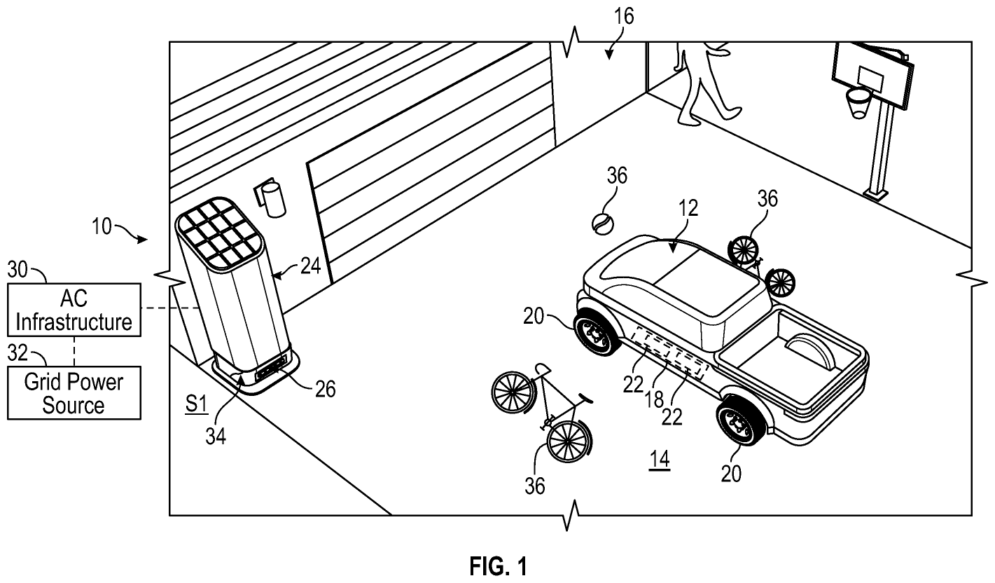

FIGS. 1, 2, and 3 schematically illustrate an exemplary self-locating charging system 10 (hereinafter “the system 10”) for wirelessly charging an electrified vehicle 12 when the electrified vehicle 12 is parked at a surface 14. In an embodiment, the surface 14 is established by a driveway associated with a structure 16 (e.g., a residential building, a commercial building, etc.). In another embodiment, the surface 14 is established by a parking lot 15 at which the system 10 may be located and configured to charge multiple electrified vehicles 12 (see FIG. 4).

Although a specific component relationship is illustrated in the figures of this disclosure, the illustrations are not intended to limit this disclosure. The placement and orientation of the various components of the depicted self-locating charging system are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 12 is a plug-in type electric vehicle (e.g., a plug-in hybrid electric vehicle (PHEV) or a battery electric vehicle (BEV)). The electrified vehicle 12 includes a traction battery pack 18 that is part of an electrified powertrain capable of applying a torque from an electric machine (e.g., an electric motor) for driving drive wheels 20 of the electrified vehicle 12. Therefore, the electrified powertrain of the electrified vehicle 12 may electrically propel the set of drive wheels 20 either with or without the assistance of an internal combustion engine.

The electrified vehicle 12 of FIGS. 1-3 is schematically illustrated as a pickup truck. However, other vehicle configurations are also contemplated. The teachings of this disclosure may be applicable for charging any type electrified vehicle 12. For example, the electrified vehicle 12 could be configured as a car, a truck, a van, a sport utility vehicle (SUV), etc.

Although shown schematically, the traction battery pack 18 may be configured as a high voltage traction battery pack that includes a plurality of battery arrays 22 (e.g., battery assemblies or groupings of battery cells) capable of outputting electrical power to one or more electric machines of the electrified vehicle 12. Other types of energy storage devices and/or output devices may also be used to electrically power the electrified vehicle 12.

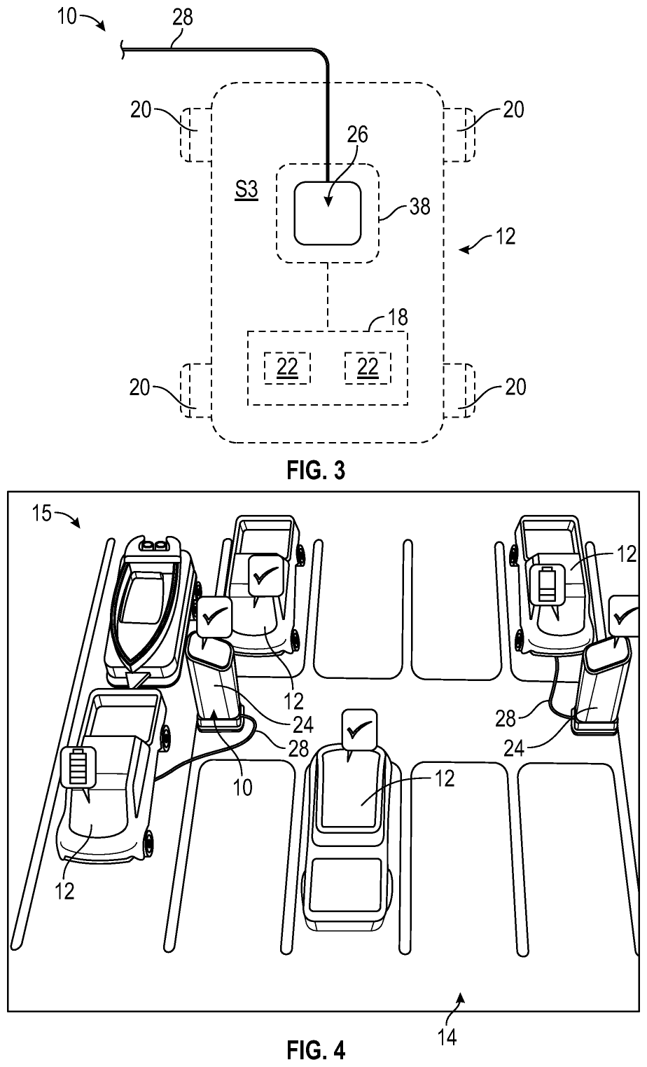

From time to time, charging the energy storage devices (e.g., battery cells) of the traction battery pack 18 may be required or desirable. The system 10 may therefore autonomously move from a stowed state S1 shown in FIG. 1 to a charging alignment state S3 shown in FIG. 3 for wirelessly charging the energy storage devices of the traction battery pack 18 of the electrified vehicle 12 with little not no user input required. The system 10 may be configured to provide hands-free inductive charging or hands-free conductive charging, for example. However, other types of wireless charging are also contemplated within the scope of this disclosure.

The system 10 may include a beacon dock 24 and a mobile rover 26. The mobile rover 26 may be operably connected to the beacon dock 24 by a tether 28. In an embodiment, the tether 28 is a high voltage power cable capable of transferring AC power, DC power, or both.

The beacon dock 24 may be mounted or otherwise positioned relative to the surface 14 and/or the structure 16 and may be operably connected to an AC infrastructure 30 of the structure 16. The beacon dock 24 may be connected to a grid power source 32 (e.g., AC power, solar power, wind power, etc., or combinations thereof) through the AC infrastructure 30.

The system 10 is shown in the stowed state S1 in FIG. 1. In this state, the mobile rover 26 may be received within a docking space 34 of the beacon dock 24. The stowed state S1 is therefore considered to be a non-charging condition of the system 10.

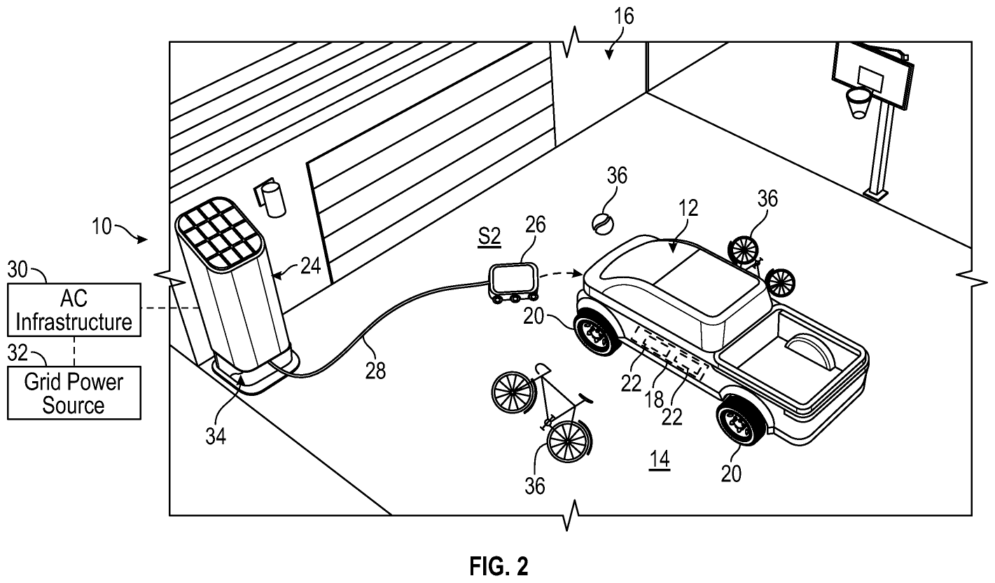

The system 10 is shown in a navigating state S2 in FIG. 2. In this state, the mobile rover 26 has deployed from the docking space 34 of the beacon dock 24 and is autonomously moving over the surface 14 toward the electrified vehicle 12. The mobile rover 26 may locate the electrified vehicle 12 and navigate around any obstacles 36 located within its desired travel path during the navigating state S2. The mobile rover 26 may travel to the electrified vehicle 12 to prepare for charging as opposed to the electrified vehicle 12 needing to travel to the system 10 as in prior charging systems.

The system 10 is shown in a charging alignment state S3 in FIG. 3. In this state, the mobile rover 26 has self-located relative to a vehicle receiver module 38 mounted on the electrified vehicle 12 without any required human interaction. The vehicle receiver module 38 (e.g., a receiving coil pad with a charging coil) may be configured to wirelessly receive power from the mobile rover 26 for wirelessly charging the traction battery pack 18 when the mobile rover 26 is properly self-aligned with the vehicle receiver module 38. As further discussed below, the mobile rover 26 may navigate to and properly self-align relative to the vehicle receiver module 38 for achieving maximum wireless power transfer and efficiency using onboard sensors and/or by directly communicating with the electrified vehicle 12.

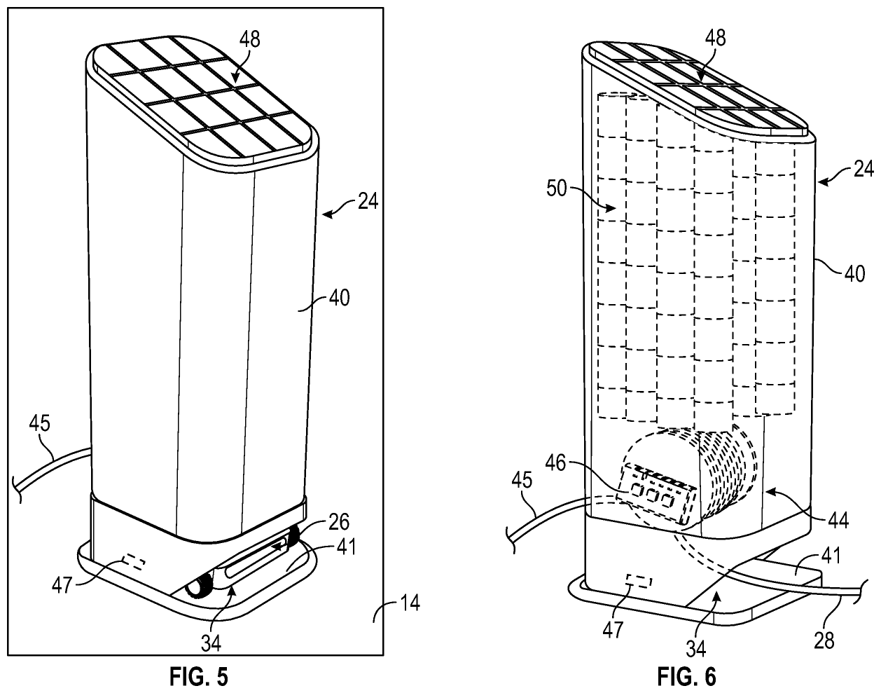

FIGS. 5, 6, 7, 8, and 9, with continued reference to FIGS. 1-4, illustrate additional features associated with the beacon dock 24 of the system 10. The beacon dock 24 may include a housing 40. In an embodiment, the housing 40 is configured as a stanchion-like structure. However, the size and shape of the housing are not intended to limit this disclosure.

A power cable 45 may extend from the housing 40. The power cable may be used to electrically couple the beacon dock to an electrical panel associated with the AC infrastructure 30 of the structure 16.

The housing 40 may provide the docking space 34 for receiving the mobile rover 26. In an embodiment, the docking space 34 extends along a horizontal axis of the housing 40 for horizontally stowing the mobile rover 26 in a position that is substantially parallel to the surface 14 (see, e.g., FIG. 5). In another embodiment, the docking space 34 extends along a vertical axis of the housing 40 for vertically stowing the mobile rover 26 in a position that is substantially transverse to the surface 14 (see, e.g., FIG. 7).

The mobile rover 26 may rest upon a docking pad 41 of the housing 40 when received within the docking space 34 (see FIGS. 5 and 6). In vertical stowing embodiments, the housing 40 may include a ramped base 42 (see FIG. 7) for allowing the mobile rover 26 to more easily enter and stow into the docking space 34. A mechanical locking mechanism 47 may be provided within the housing 40 to lock the mobile rover 26 relative to the housing 40 when in the stowed state S1.

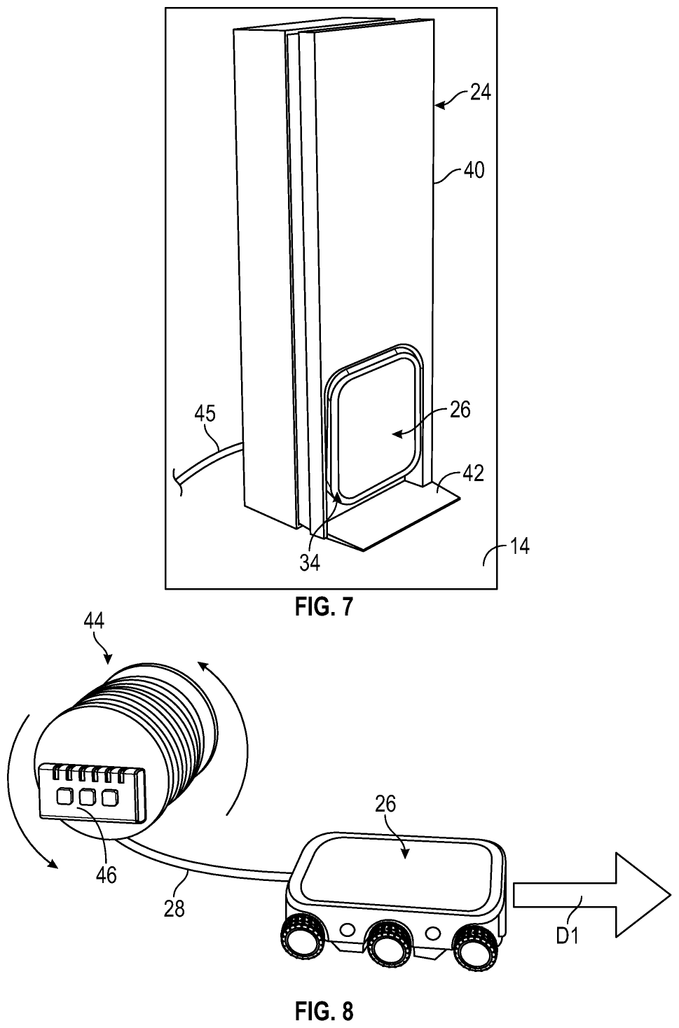

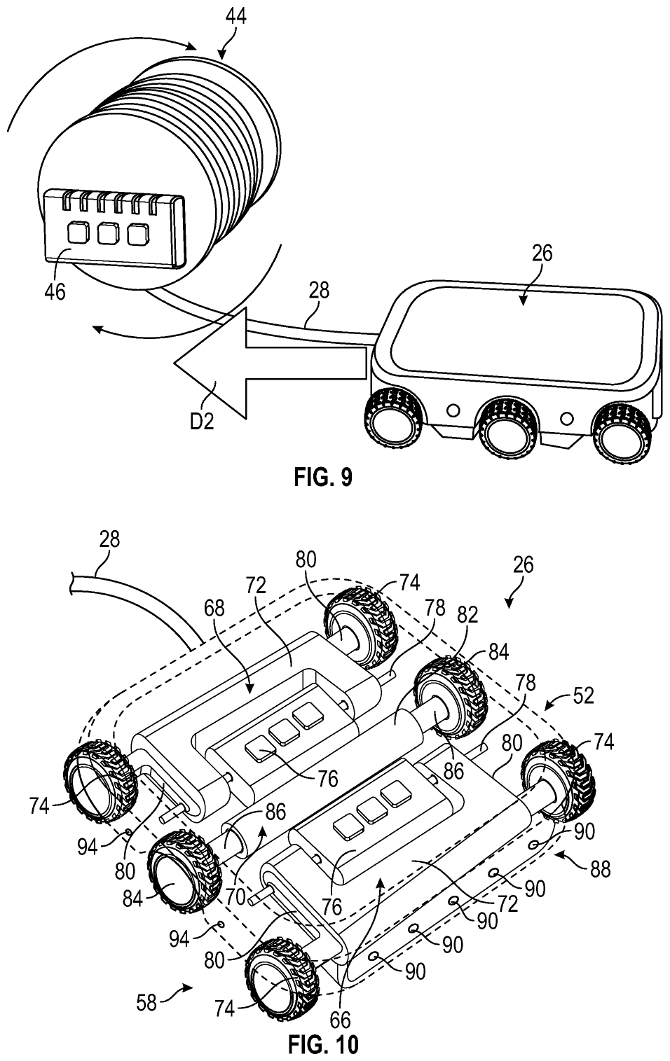

An automatic cable reel 44 may be housed within the housing 40 of the beacon dock 24. The automatic cable reel 44 may either release the tether 28 or collect the tether 28 in coordination with movement of the mobile rover 26 to prevent slack in the tether 28. For example, the automatic cable reel 44 may automatically rotate in a first direction to unwind or otherwise release the tether 28 as the mobile rover 26 moves in a first direction D1 away from the beacon dock 24 (see FIG. 8), and the automatic cable reel 44 may automatically rotate in a second, opposite direction to wind or otherwise collect the tether 28 as the mobile rover 26 moves in a second direction D2 toward the beacon dock 24 (see FIG. 9). An electric motor 46 of the automatic cable reel 44 may control the reel rotation for either winding or unwinding the tether 28 depending on the direction of travel of the mobile rover 26.

The beacon dock 24 may further include a solar panel 48 and a battery bank 50 that are operably coupled to one another. The solar panel 48 may be mounted near an upper surface of the housing 40 and may include one or more photovoltaic modules adapted for harnessing solar energy. The solar energy may be used to charge the battery bank 50. The battery bank 50 may alternatively or additionally be charged using power from the grid power source 32.

The battery bank 50 may be housed inside the housing 40 and may include plurality of interconnected battery cells capable of storing electrical energy. However, other types of energy storage devices are also contemplated within the scope of this disclosure. The battery bank 50 may selectively power the mobile rover 26, such as when power is temporarily unavailable from the grid power source 32, for example.

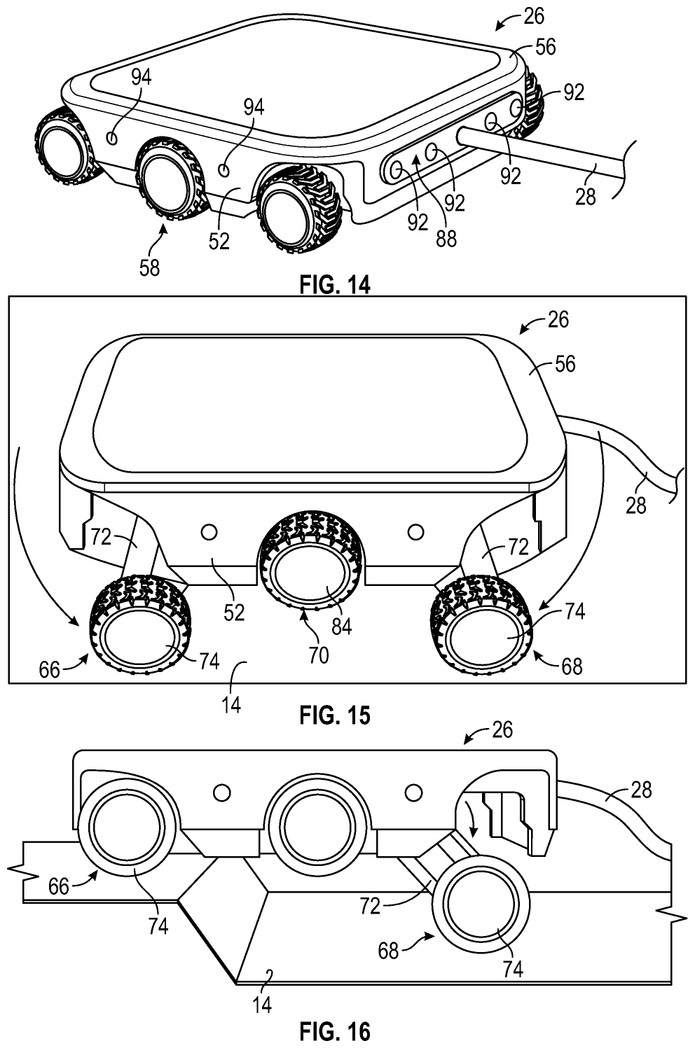

FIGS. 10, 11, 12, 13, and 14, with continued reference to FIGS. 1-9, illustrate additional features associated with the mobile rover 26 of the system 10. The mobile rover 26 may include a casing 52 that houses various subcomponents of the mobile rover 26. The casing 52 may embody any size and shape within the scope of this disclosure.

A transmitting module 54 (e.g., a wireless transmitting coil pad that includes a charging coil) may be housed inside the casing 52 (see exploded view of FIG. 12). In an embodiment, the transmitting module 54 is housed just beneath a lid 56 of the casing 52. In another embodiment, the transmitting module 54 is embedded within the lid 56. However, other arrangements could also be suitable within the scope of this disclosure.

An electromagnetic field can be produced when the transmitting module 54 is properly aligned relative to the vehicle receiver module 38, thereby allowing for electrical energy to be wirelessly transferred from the transmitting module 54 to the vehicle receiver module 38 during vehicle charging events. The electrical energy may subsequently be used to charge the traction battery pack 18 of the electrified vehicle 12.

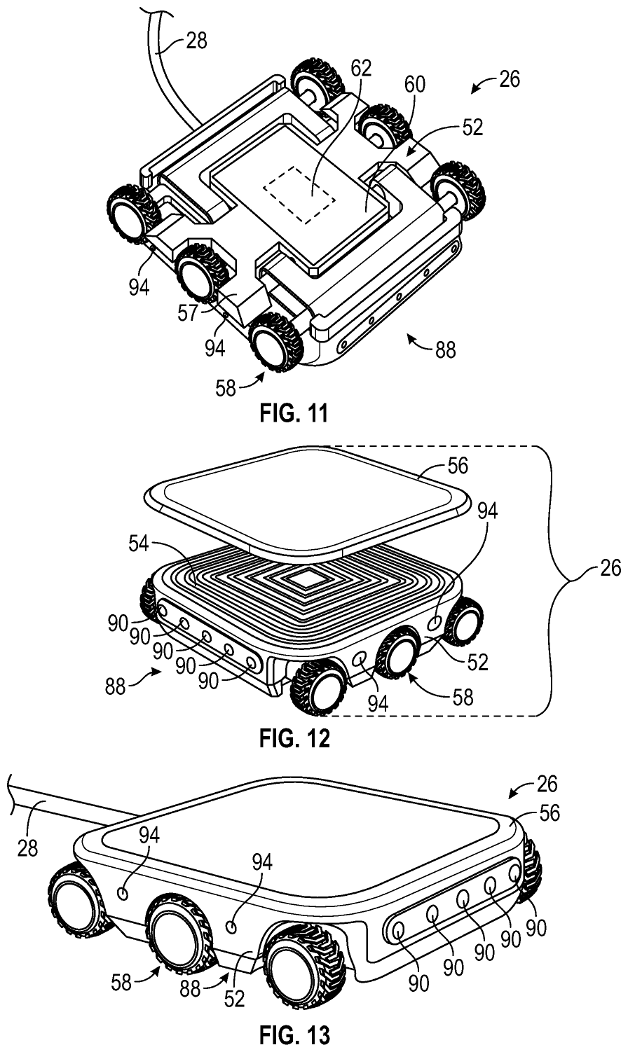

An underside 57 (best shown in FIG. 11) of the casing 52 may include an access panel 60. The access panel 60 may be removed from the casing 52 for accessing various electronics housed therein. The electronics may include a control module 62, for example. As further discussed below, the control module 62 may be programmed to control movement of the mobile rover 26 between the various states S1, S2, and S3.

The mobile rover 26 may further include a drive system 58 for propelling the mobile rover 26 over the surface 14 when moving between the stowed state S1 and the charging alignment state S3. The drive system 58 may include one or more axle assemblies. In an embodiment, the drive system 58 includes a first or front axle assembly 66, a second or rear axle assembly 68, and a third or mid-axle assembly 70.

Each of the front axle assembly 66 and the rear axle assembly 68 may include a swing axle 72, a pair of wheels 74, an electric motor 76, and a pivot pin 78. The pivot pin 78 may connect the electric motor 76 to the swing axle 72. The wheels 74 may be connected to the swing axle 72 by shafts 80.

The electric motor 76 may be configured to power movement of the mobile rover 26. In an embodiment, the front axle assembly 66 and the rear axle assembly 68 may be powered independently of one another for achieving various operating maneuvers of the mobile rover 26. For example, the mobile rover 26 may be moved forward, backward, side-to-side, in a spinning motion, etc. by selectively powering the front axle assembly 66 and/or the rear axle assembly 68 via the electric motors 76.

The mid-axle assembly 70 may be disposed axially between the front and rear axle assemblies 66, 68 and may include an axle 82 and a pair of wheels 84 connected to the axle 82 by half shafts 86. The mid-axle assembly 70 may either be a non-driven axle or could be driven by an additional electric motor (not shown).

The drive system 58 may be controlled to position the casing 52 (and the transmitting module 54) of the mobile rover 26 in a raised position, such as for accommodating vehicles having a relatively large ground clearance. To achieve the raised position, the electric motors 76 of the front and rear axle assemblies 66, 68 may be controlled to pivot the swing axles 72 about the pivot pins 78, thereby raising the casing 52 of the mobile rover further above the surface 14 (see FIG. 15). In the raised position, the wheels 84 of the mid-axle assembly 70 are moved upwardly such that they no longer contact the surface 14.

The drive system 58 may further be controlled to automatically level the mobile rover 26 when uneven terrain of the surface 14 is encountered during movement. To achieve auto-leveling, the electric motor 76 of either front or rear axle assembly 66, 68 may be independently controlled to pivot the swing axle 72 about the pivot pin 78, thereby raising either the front or the rear of the casing 52 of the mobile rover 26 for navigating across the uneven terrain (see FIG. 16).

The drive system 58 shown in FIGS. 10-14 is illustrated as including a total of three axle assemblies and six wheels. However, a greater or fewer number of axles/wheels may be provided as part of the drive system 58 of the mobile rover 26 within the scope of this disclosure.

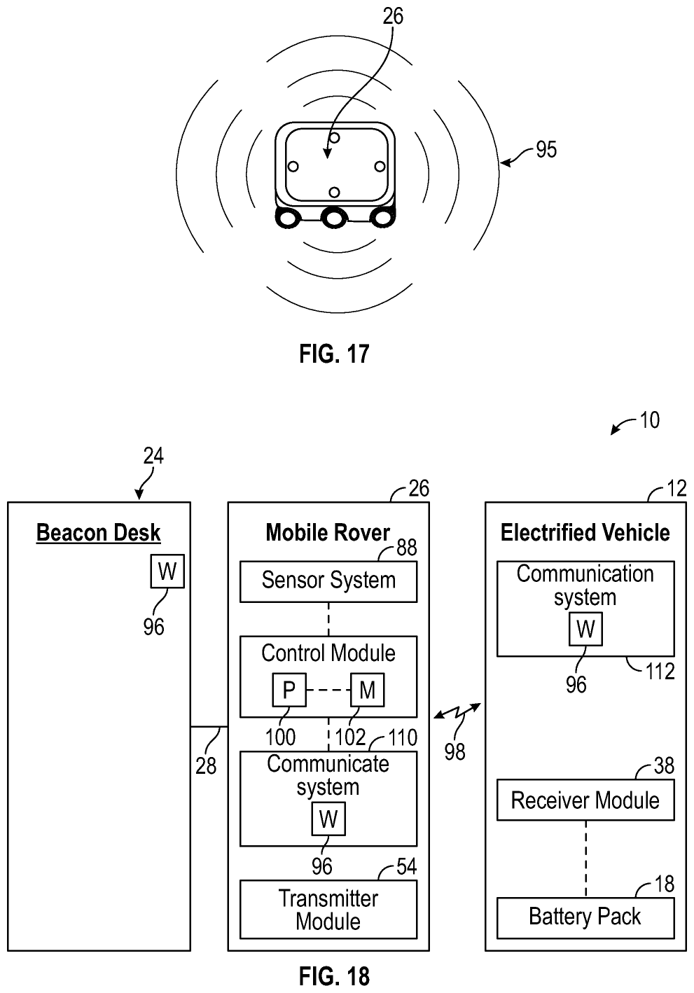

The mobile rover 26 may further include a sensor system 88. The sensor system 88 may sense characteristics associated with an operating environment of the mobile rover 26 in order to determine an optimal travel path the mobile rover 26 needs to follow for evading any obstacles 36 and for properly aligning the mobile rover 26 relative to the vehicle receiver module 38. The sensor system 88 may include one or more front sensors 90, rear sensors 92, and side sensors 94. The sensors 90, 92, 94 may include proximity sensors, lidar sensors, cameras, capacitive sensors, ultrasonic sensors, magnetic sensors, infrared sensors, induction sensors, radar sensors, or any other type of sensors or combination of sensors. In an embodiment, the sensor system 88 is configured to provide a full 360 degree field-of-view 95 about the mobile rover 26 (see FIG. 17). In another embodiment, the sensor system 88 may leverage additional sensor information received from the beacon dock 24 and/or the electrified vehicle 12 when mapping the operating environment surrounding the mobile rover 26.

Additional functionality of the self-locating charging system 10 is schematically illustrated with reference to the block diagram of FIG. 18 (with continued reference to FIGS. 1-17). In particular, FIG. 18 schematically illustrates features that enable the system 10 to self-locate the mobile rover 26 relative to the vehicle receiver module 38 in order to wirelessly charge the traction battery pack 18 of the electrified vehicle 12. The system 10 is capable of locating and traveling to the electrified vehicle 12 rather than vice-versa and irrespective of how the electrified vehicle 12 is parked, thereby providing a more convenient and efficient hands-free charging solution.

In an embodiment, the system 10 includes a communication system 110 for facilitating communications with a corresponding communication system 112 of the electrified vehicle 12. Each communication system 110, 112 may include one or more wireless devices 96 that can facilitate bidirectional communications between the system 10 and the electrified vehicle 12. Various information and signals may be exchanged between the system 10 and the electrified vehicle 12 via the wireless devices 96. In an embodiment, the wireless devices 96 are Bluetooth® Low Energy (BLE) transceivers configured to receive and/or emit low energy signals as a way to detect and communicate with the electrified vehicle 12 in anticipation of performing a wireless charging event. However, other types of wireless devices (e.g., WiFi, V2X, NFC, RF, etc.) are also contemplated within the scope of this disclosure for enabling bidirectional communications between the system 10 and the electrified vehicle 12. The wireless devices 96 of the communication system 110 may be provided on the mobile rover 26, the beacon dock 24, or both.

The control module 62 of the mobile rover 26 may include both hardware and software and may be programmed with executable instructions for interfacing with and commanding operation of various subcomponents of the system 10. Although shown as being a single controller of the mobile rover 26, the control module 62 could include one or more controllers that communicate with one another for controlling the system 10. For example, both the beacon dock 24 and the mobile rover 26 could include controllers that together establish the control module 62.

The control module 62 may include a processor 100 and non-transitory memory 102 for executing various control strategies and modes associated with the system 10. The processor 100 may be custom made or commercially available processors, central processing units (CPUs), or generally any device for executing software instructions. The memory 102 can include any one or combination of volatile memory elements and/or nonvolatile memory elements. The processor 100 may be operably coupled to the memory 102 and may be configured to execute one or more programs stored in the memory 102 based on various inputs received from other devices associated with the system 10.

In an embodiment, upon arriving and parking at a desired location of the surface 14, the wireless device(s) 96 of the electrified vehicle 12 system 10 may broadcast wireless signals 98 that may be received by the wireless device(s) 96 of the system 10, thereby indicating to the control module 62 that a wireless charging event is desired. Based on additional information received from the sensor system 88, the control module 62 can determine the exact location of the electrified vehicle 12, and more particularly the vehicle receiver module 38, relative to the mobile rover 26. The control module 62 may then determine the correct travel path the mobile rover 26 needs to travel over in order to properly align the transmitting module 54 to the vehicle receiver module 38 for initiating the wireless charging event. The control module 62 may then command the drive system 58 to move the mobile rover 26 over the desired travel path.

In another embodiment, as part of determining the desired travel path of the mobile rover 26, the control module 62 may be programmed to identify and account for any obstacles 36 that may be located near or around the location where the electrified vehicle 12 is parked on the surface 14. The control module 62 may further be programmed to control the mobile rover 26 to maneuver around such obstacles 36 when moving to the charging alignment state S3.

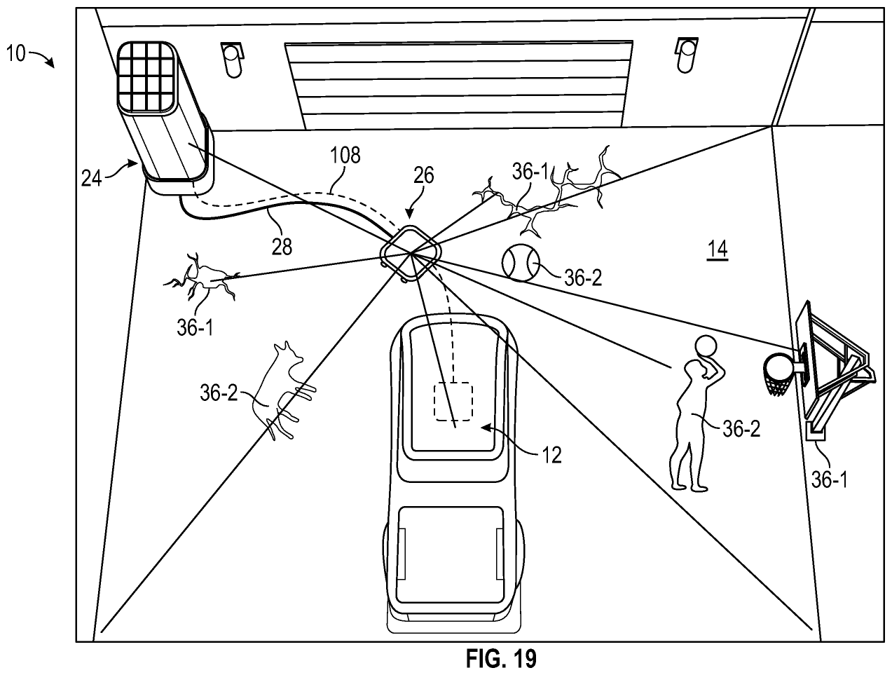

The control module 62 may further be programmed, based at least in part on environmental feedback signals received from the sensor system 88, to learn about its operating environment and optimize its travel paths over time by leveraging machine learning techniques. This may include the ability to distinguish between permanent obstacles 36-1 (e.g., bushes, fixed structures, holes or other imperfections in or near the surface 14, etc.) and variable obstacles 36-2 (e.g., sleeping pets, inanimate objects, humans, etc.) when mapping a desired travel path 108 of the mobile rover 26 (see, e.g., FIG. 19).

The control module 62 may further be programmed, based at least in part on environmental feedback signals received from the sensor system 88, to infer situations in which it may not be desirable to charge the electrified vehicle 12. This may include situations in which the electrified vehicle 12 is parked on the surface 14 at greater than a threshold distance from a typical parking position, when it is unknown how long the user of the electrified vehicle 12 plans to stay parked on the surface 14, etc.

The control module 62 may further be programmed to command the system 10 to end the wireless charging event when certain conditions exist. For example, the wireless charging event may be commanded to end in response to receiving a signal from the electrified vehicle 12 indicating that the user has reentered the electrified vehicle 12 and is likely to soon attempt to exit the surface 14. In such a situation, the electrified vehicle 12 may be configured to either prevent vehicle movement until the mobile rover 26 has returned to the beacon dock 24 or to back straight up to prevent damaging the mobile rover 26 during the movement.

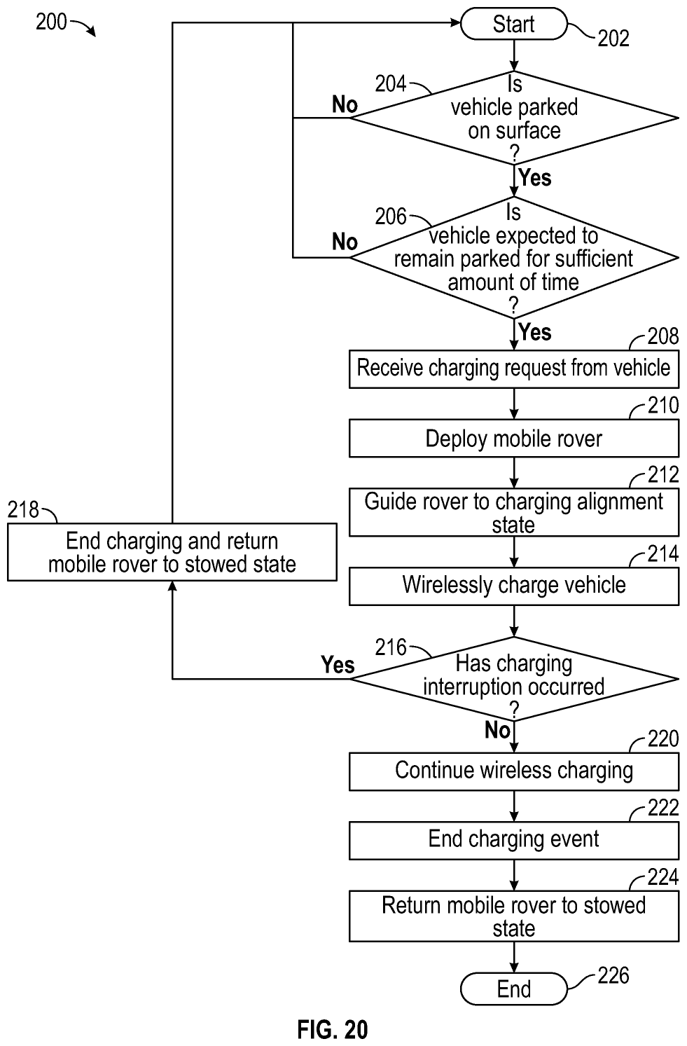

FIG. 20, with continued reference to FIGS. 1-19, schematically illustrates in flow chart form an exemplary method 200 for controlling the system 10 for coordinating and executing wireless charging events. The system 10 may be configured to employ one or more algorithms adapted to execute the steps of the exemplary method 200. For example, the method 200 may be stored as executable instructions in the memory 102 of the control module 62, and the executable instructions may be embodied within any computer readable medium that can be executed by the processor 100 of the control module 62.

The exemplary method 200 may begin at block 202. At block 204, the method 200 may determine whether the electrified vehicle 12 is parked on the surface 14. The electrified vehicle 12 may communicate directly with the system 10 (e.g., via the wireless devices 96) and/or or may leverage information from the sensor system 88 for making this determination.

If a YES flag is returned at block 204, the method 200 may proceed to block 206. At this step, the system 10 may determine whether the electrified vehicle 12 is likely to be parked for a sufficient amount of time to meaningfully charge the electrified vehicle 12. The user may be sent an alert when the system 10 and/or the electrified vehicle 12 are unsure how long the electrified vehicle 12 is likely to remain parked on the surface 14.

If a YES flag is returned at block 206, the method 200 may next proceed to block 208. At this step, the system 10 may receive a charging request from the electrified vehicle 12. The system 10 may then deploy the mobile rover 26 from the beacon dock 24 at block 210. The system 10 may communicate with the electrified vehicle 10 for guiding the mobile rover 26 to the charging alignment state S3 at block 212. The system 10 may then be controlled to wirelessly charge the electrified vehicle 12 at block 214.

Next, at block 216, the method 200 may determine whether a charging interruption has occurred. Charging interruptions may occur, for example, when the user reenters the electrified vehicle 12 and indicates a desire to drive away from the surface 14 (e.g., such as by starting the vehicle). If YES, the method 200 may proceed to block 218 by ending the charging and returning the mobile rover 26 to the stowed state S1. The mobile rover 26 may be commanded to travel along a reverse path of the travel path it took to reach the charging alignment state S3 in order to return to the stowed state S1.

Alternatively, if a NO flag is returned at block 216, the method 200 may instead proceed to block 220 by continuing the wireless charging event. Once charging has completed, the charging event may end at block 222 and the mobile rover 26 may return to the stowed state S1 at block 224. The mobile rover 26 may be commanded to travel along a reverse path of the travel path it took to reach the charging alignment state S3 in order to return to the stowed state S1. The method 200 may then end at block 226.

The self-locating charging systems and methods of this disclosure are designed to provide a self-locating, hands-free charging solution for guiding the charging system relative to parked vehicles in preparation for performing charging events. The system may provide accurate and efficient wireless charging regardless of the manner in which the vehicle is parked and that require little to no direct input from users.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A self-locating charging system, comprising:
a beacon dock; and
a mobile rover configured to move between a stowed state within a docking space of the beacon dock and a charging alignment state in which the mobile rover is aligned to a vehicle receiver module for wirelessly transferring power,
wherein the mobile rover includes a drive system comprising an axle assembly that includes a swing axle, a pair of wheels, an electric motor, and a pivot pin.

2. The self-locating charging system as recited in claim 1, wherein the beacon dock includes a solar panel and a battery bank.

3. The self-locating charging system as recited in claim 1, wherein the docking space extends along a horizontal axis of the beacon dock for horizontally stowing the mobile rover.

4. The self-locating charging system as recited in claim 1, wherein the docking space extends along a vertical axis of the beacon dock for vertically stowing the mobile rover.

5. The self-locating charging system as recited in claim 4, wherein the beacon dock includes a ramped base for vertically stowing the mobile rover.

6. The self-locating charging system as recited in claim 1, wherein the mobile rover is connected to the beacon dock by a tether.

7. The self-locating charging system as recited in claim 6, wherein the beacon dock includes an automatic cable reel that is configured to either release the tether or collect the tether in coordination with a direction of movement of the mobile rover.

8. The self-locating charging system as recited in claim 1, wherein the axle assembly is a front axle assembly, and the drive system further comprises a rear axle assembly including a second swing axle, a second pair of wheels, a second electric motor, and a second pivot pin.

9. The self-locating charging system as recited in claim 8, wherein the rear axle assembly and the front axle assembly are powered independently from one another.

10. The self-locating charging system as recited in claim 8, comprising a mid-axle assembly positioned between the rear axle assembly and the front axle assembly.

11. The self-locating charging system as recited in claim 1, wherein the mobile rover includes a sensor system configured to monitor a 360 degree field-of-view about the mobile rover.

12. The self-locating charging system as recited in claim 1, wherein the mobile rover includes a first communication system configured to communicate with a second communication system of an electrified vehicle that comprises the vehicle receiver module.

13. The self-locating charging system as recited in claim 1, wherein the mobile rover includes a casing and a transmitting module housed within the casing.

14. The self-locating charging system as recited in claim 1, wherein the swing axle is configured to pivot about the pivot pin to either raise or lower a casing of the mobile rover relative to a surface.

15. The self-locating charging system as recited in claim 1, comprising a control module programmed to control the drive system for operating the mobile rover along a desired travel path between the stowed state and the charging alignment state.

16. A self-locating charging system, comprising:
a beacon dock;
a mobile rover configured to move between a stowed state within a docking space of the beacon dock and a charging alignment state in which the mobile rover is aligned to a vehicle receiver module of an electrified vehicle for wirelessly transferring power; and
a control module programmed to control movement of the mobile rover along a desired travel path between the stowed state and the charging alignment state,
wherein the control module is further programmed to distinguish between a permanent obstacle and a variable obstacle when mapping the desired travel path.

17. The self-locating charging system as recited in claim 16, comprising a first communication system configured to communicate with a second communication system of the electrified vehicle for moving the mobile rover along the desired travel path.

18. The self-locating charging system as recited in claim 16, wherein the control module is further programmed to control the mobile rover along the desired travel path based on feedback from a sensor system that is adapted to monitor a 360 degree field-of-view about the mobile rover.

19. The self-locating charging system as recited in claim 16, wherein the control module is further programmed to command the mobile rover to return to the stowed state when a wireless charging event either ends or is interrupted.

20. The self-locating charging system as recited in claim 19, wherein the mobile rover travels along a reverse path of the desired travel path when ordered to return to the stowed state.
